(19) United States
(12) Patent Application Publication
(10) Pub. No.: US 2018/0267138 A1
(43) Pub. Date: Sep. 20, 2018

(54) RADAR DEVICE

(71) Applicant: DENSO CORPORATION, Kariya-city, Aichi-pref. (JP)

(72) Inventors: Kazumasa Sakurai, Nishio-city, Aichi-pref. (JP); Kazushi Kawaguchi, Nishio-city, Aichi-pref. (JP); Yuji Sugimoto, Nishio-city, Aichi-pref. (JP); Asahi Kondo, Kariya-city, Aichi-pref. (JP)

(21) Appl. No.: 15/754,839

(22) PCT Filed: Jul. 28, 2016
(86) PCT No.: PCT/JP2016/072197

§ 371 Date: Feb. 23, 2018

(30) Foreign Application Priority Data
Aug. 25, 2015 (JP) 2015-165907

(51) Int. Cl. G01S 7/03; H01Q 1/42; H01Q 15/02

(52) U.S. Cl. CPC G01S 7/032; G01S 13/931; H01Q 15/02; H01Q 1/42

(57) ABSTRACT

A radar device is equipped with a radar emitting section, a radar input section, a detector, and a cover. The radar emitting section radiates an electromagnetic wave. The radar input section receives a return of the electromagnetic wave from an object. The detector works to detect the object using the return of the electromagnetic wave inputted to the radar input section. The cover covers an object portion that is at least one of the radar emitting section and the radar input section. The cover is designed to have a convex lens formed on a portion of the cover through which the electromagnetic wave passes to the object portion. The cover is made in the form of a radome. The structure of such a radome serves to decrease the power consumption of the radar device.

### CROSS REFERENCE TO RELATED DOCUMENT

The present application claims the benefit of priority of Japanese Patent Application. No. 2015-465907 filed on Aug. 25, 2015, the disclosure of which is incorporated herein by reference.

### TECHNICAL FIELD

The present invention generally relates to a radar device working to transmit electromagnetic waves and receive returns thereof to detect an object.

### BACKGROUND ART

A technique of improving characteristics of a radar device using a radome that is a cover for an antenna which transmits or receive a radar wave is known.

For example, Japanese Patent First Publication No. 2009-103456 teaches a radar device equipped with a radome which is oriented non-perpendicular to a transmitting direction in an antenna in order to prevent a transmitted radio wave from being reflected on the radome and then inputted to the antenna.

### SUMMARY OF THE INVENTION

### Problem to be Solved by the Invention

In recent years, the number of devices mounted in a vehicle has been increased, so that the number of functions thereof are increased, thus resulting in a great increase in power consumption thereof. It is desirable to decrease the power consumption in each of the devices, e.g., a radar device, mounted in the vehicle.

It is an object of the invention to provide a technique of reducing electrical power consumed by a radar device by means of a structure of a radome.

### Means for Solving the Problem

According to one aspect of the invention, there is provided a radar device which comprises a radar section, a radar input section, a detector, and a cover. The radar emitting section emits an electromagnetic wave. The radar input section receives a return of the electromagnetic wave from an object. The detector works to detect the object using the return of the electromagnetic wave inputted to the radar input section. The cover serves to cover an object portion that is at least one of the radar emitting section and the radar input section. The cover has a convex lens formed on a portion of the cover through which the electromagnetic wave is transmitted to the object portion.

In the above arrangements, when the cover is designed to cover the radar emitting section, the operation of the lens made in the form of a convex lens serves to minimize the spreading of an electromagnetic wave radiated from the radar device, thereby facilitating the collimation of the electromagnetic wave. The magnitude of the electromagnetic wave in a given area located at a given distance away from the radar device when the electromagnetic wave is collimated and then radiated is greater than that when the electromagnetic wave is radiated and then spreads. When the cover is designed to cover the radar input section, the operation of the lens made in the form of a convex lens facilitates the ease with which an electromagnetic wave entering the radar device is focused on the radar input section.

Accordingly, the radar device of the invention is capable of decreasing an amplification factor of an electromagnetic wave when radiated or when inputted. This results in a decrease in electric power consumed to actuate an amplifier, which leads to a reduction in power consumption in the radar device.

### BRIEF DESCRIPTION OF THE DRAWINGS

FIG. 1 is a view which illustrates an example of a location of a radar device in a vehicle in the first embodiment.

FIG. 2 is a sectional view, as indicated by a chain line in FIG. 1, and a view which illustrates a structure of a radar device in the first embodiment.

FIG. 3 is a view which illustrates an example of directivity of a transmitting antenna.

FIG. 4 is a view for explaining an operation of a lens 215.

FIG. 5(a) is a view for explaining an operation of a radar device in the first embodiment.

FIG. 5(b) is a view for explaining an operation of a comparative example of a radar device equipped with no lens.

FIG. 6(a) is a view for explaining an operation of a comparative example of a radar device in which a distance L between a principal point S of a lens and a transmitting antenna is less than a focal length of the lens.

FIG. 6(b) is a view for explaining an operation of a comparative example of a radar device in which a distance L is greater than a focal length of a lens.

FIG. 7 is a view which illustrates a structure of a modified form of a radar device in the first embodiment which is equipped with lenses for a transmitting antenna and a receiving antenna.

FIG. 8 is a view which illustrates an example of directivity of a receiving antenna.

FIG. 9 is a view which illustrates a structure of a radar device in the second embodiment.

FIG. 10 is a view for explaining an operation of a lens in the second embodiment.

FIG. 11 is a view which illustrates a modified form of a radar device in the second embodiment which is equipped with lenses for a transmitting antenna and a receiving antenna.

### EMBODIMENTS FOR CARRYING OUT THE INVENTION

Embodiments to which the invention is applied will be described below using the drawings.

### 1. First Embodiment

### [1-1. Structure]

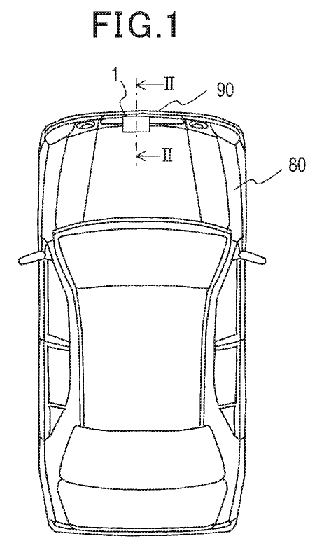

The radar device 1 of this embodiment is, as illustrated in FIG. 1, arranged, as an example, inside the front bumper 90 of the vehicle 80. The radar device 1 works to radiate an electromagnetic wave and detect a target object using a return of the electromagnetic wave from the target object. The object is, for example, one of various physical objects, such as vehicles, pedestrians, or buildings. This embodiment refers to the radar device 1 which is designed, as an example, to emit a millimeter-band radio wave as an electromagnetic wave. The radar device 1 may be engineered to use light, such as infrared light, as the electromagnetic wave instead of the millimeter-band radio wave.

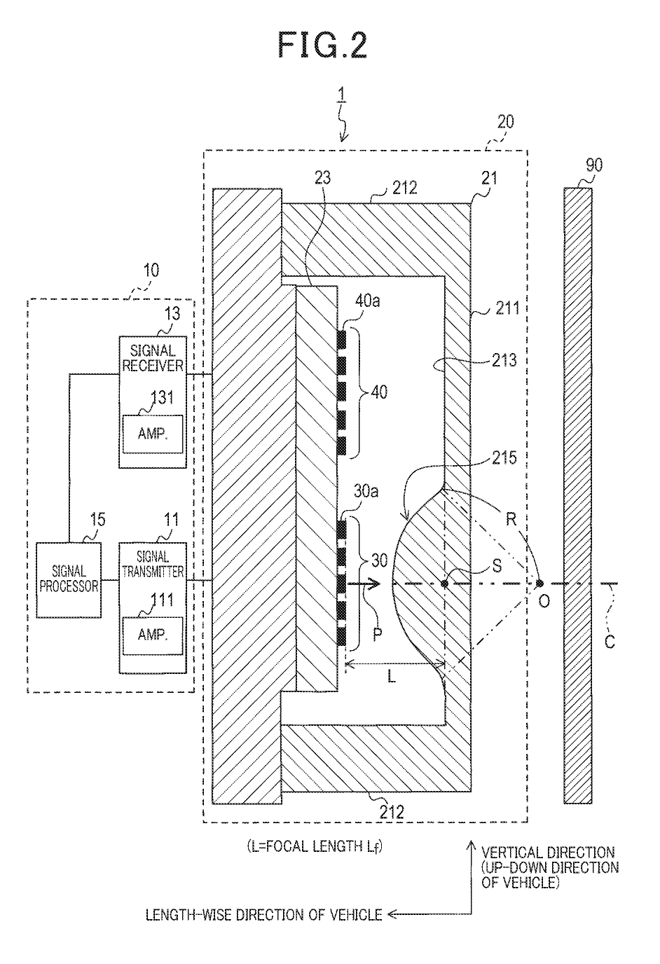

The radar device 1 is, as illustrated in FIG. 2, equipped with the main unit 10 (which will be referred to below as a radar unit) and the antenna unit 20.

The radar unit 10 at least includes the signal transmitter 11, the signal receiver 13, and the signal processor 15. The antenna unit 20 at least includes the transmitting antenna 30, the receiving antenna 40, and the cover 21.

The signal transmitter 11 produces radio waves in response to an output from the signal processor 15. The radio waves are radiated from the transmitting antenna 30 toward, for example, an object in front of the vehicle 80. The signal transmitter 11 is equipped with the amplifier 111 which amplifies the produced radio waves to have a given electrical power and outputs them to the transmitting antenna 30.

The radio wave, as produced by the signal transmitter 11, may be a pulsed wave or a continuous wave. The continuous wave may be frequency-modulated. The frequency modulation may be made to modulate a carrier wave whose frequency is linearly increased or decreased with time according to a triangular-wave modulating signal. Specifically, the radar device 1 may be engineered in the form of a pulse radar, a CW radar, an FMCW radar, or another type of radar.

The transmitting antenna 30 transmits a radio wave. Specifically, the transmitting antenna 30 is made of a plurality of antenna devices 30a in the form of an antenna array. The antenna devices 30a of the antenna array may be made in the form of a patch antenna or a horn antenna or shaped to match the transmitting frequency. The antenna devices 30a are arrayed on the antenna board 23 in a vertical direction of the vehicle 80 when the radar device 1 is mounted in the vehicle 80 to constitute one channel.

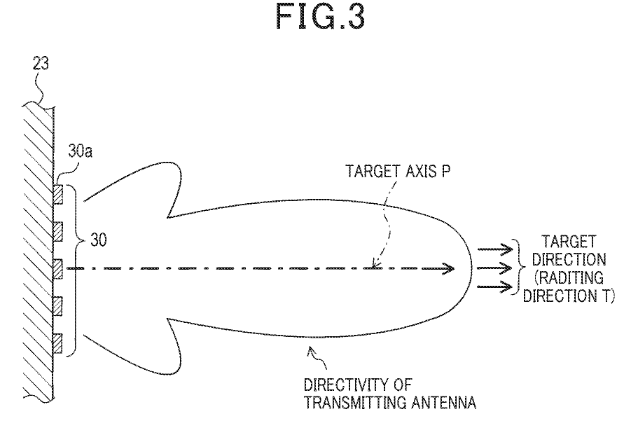

The transmitting antenna 30 transmits the radio wave outputted from the signal transmitter 11. In the antenna array of this embodiment, the signal transmitter 11 outputs radio waves which are in phase with each other to all the antenna devices 30a. This causes, as illustrated as an example in FIG. 3, the directivity to become great in a direction perpendicular to the vertical direction (i.e., the lengthwise direction of the vehicle in this embodiment) with an increase in length of the array of the antenna devices 30a in the vertical direction.

In the following discussion, a radiating direction T in which an output power of a radio wave emitted from the transmitting antenna 30 becomes greatest will be referred to as a target direction. An axis which extends the transmitting antenna 30 in the target direction (i.e., the radiating direction T) will be referred to as a target axis P.

Specifically, the transmitting antenna 30 works to emit the radio wave in a given azimuth range whose center is the target axis P in front of the vehicle 80. Referring back to FIG. 2, the receiving antenna 40 receives the radio wave. Specifically, the receiving antenna 40 is arranged above the transmitting antenna 30 in the vertical direction. The receiving antenna 40, like the transmitting antenna 30, is made of a plurality of antenna devices 40a in the form of an antenna array.

The antenna devices 40a are arranged on the antenna board 23 in the vertical direction to constitute one channel. The receiving antenna 40 may alternatively be designed to have such channels disposed horizontally, i.e., in the width-wise direction of the vehicle 80 when the radar device 1 is mounted in the vehicle 80 to form multiple channels.

The receiving antenna 40 receives a reflected wave through each of the antenna devices 40a. The reflected wave is a radio wave which has been emitted from the transmitting antenna 30 and reflected by an object.

The transmitting antenna 30 or the receiving antenna 40 is not limited to the antenna array, but may be made of a single antenna device.

The signal receiver 13 is equipped with the amplifier 131 which amplifies the radio wave received by the receiving antenna 40, that is, the reflected wave which has been emitted from the transmitting antenna 30 and then returned by an object and executes preprocessing, such as a sampling operation, on the amplified reflected wave which is required to detect the object.

The signal processor 15 is equipped with a known microcomputer including a CPU, a ROM, and a RAM. The signal processor 15 uses the reflected wave which has been preprocessed by the signal receiver 13 and the radio wave produced by the signal transmitter 11 to detect the object and calculate a distance to the object through known techniques, such as TOF (Time Of Flight) measurement and a strength distribution (Received Signal Strength) indicator.

The signal processor 15 works to calculate an azimuth direction of an object using a phase difference among the reflected waves received by the antenna devices 40a. The azimuth direction, as referred to herein, is expressed by, for example, an angle from a predefined frontal direction of the antenna devices 40a. In this embodiment, the frontal direction is set to the target direction that is a direction in which a target axis Q of the receiving antenna 40, as will be described later, extends. Such measurement of the azimuth direction may be achieved using beam forming or MUSIC (Multiple Signal Classification) techniques.

The cover 21 will next be described. The cover 21 covers the transmitting antenna 30 and the receiving antenna 40 and is made of material through which a millimeter-band radio wave is permitted to transmit. The cover 21 is made in the form of a radome. In this embodiment, the cover 21 is shaped to cover both the transmitting antenna 30 and the receiving antenna 40.

This embodiment refers to the transmitting antenna 30 as corresponding to an object portion recited in claims. The object portion is at least one of the transmitting antenna 30 and the receiving antenna 40 which is covered by the cover 21 and achieves transmission of the radio wave through a lens, as will be described later.

The cover 21 is equipped with a cover central portion 211 shaped in the form of a plate and the wall 212. The wall 212 extends from a peripheral edge of the cover central portion 211 in the same direction, i.e., toward the antenna board 23 on which the transmitting antenna 30 is disposed. The cover central portion 211 has the lens 215 formed in a convex shape on a portion thereof through which the radio wave passes toward the transmitting antenna 30. The lens 215 is formed as a convex lens including a portion of the cover 21 (i.e., the cover central portion 211).

The lens 215 is formed on the surface 213 of the cover central portion 211 which faces the antenna board 23. The lens 215 has a curved surface bulging toward the transmitting antenna 30. Specifically, the lens 215 has a radius of curvature R. If a circle having the radius of curvature R is defined, the center O of the circle is located on the opposite side of the cover central portion 211 to the transmitting antenna 30. The lens 215 has a surface extending along an arc of the circle.

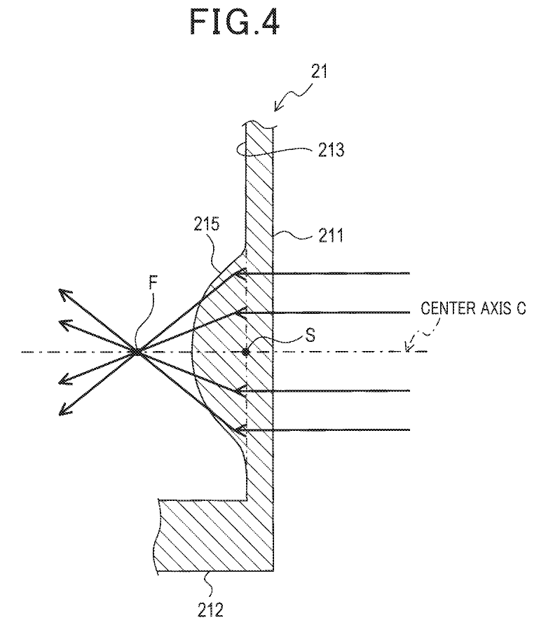

The lens 215 is, as illustrated in FIG. 4, designed so that if a distance between the principal point S and the focal point F is, like a known convex lens, defined as the focal length L_{f}, and radio waves enter the lens 215 parallel at the principal point. S, the waves are converged on the focal point F. In other words, if radio waves are emitted from the focal point F to the principal point S, they are radiated substantially parallel to each other through the lens 215. In the following discussion, a line extending between the principal point S and the focal point F will be referred to as a center axis C of the lens 215.

Referring back to FIG. 2, in this embodiment, the lens 215 is designed so that the center axis C coincides with the target axis P of the transmitting antenna 30, and the distance L between the principal point S and the transmitting antenna 30 is identical or substantially equal to the focal length L_{f} of the lens 215.

In this disclosure (including claims), the meaning of “substantially coincide” is considered to contain an error range around coincidence and offer substantially the same beneficial advantages as those in the event of coincidence. This applies to the meaning of “substantially parallel”, as will be discussed later. Specifically, the meaning of “substantially parallel” is considered to have an error range around a parallel condition, and offer substantially the same beneficial advantages as those in the parallel condition.

In this embodiment, the lens 215 is formed to meet all conditions (1) to (3) discussed below.

(1) The lens 215 is oriented to have the center axis C exactly or substantially coinciding with the target direction (i.e., the radiating direction 71. The target direction is the radiating direction T in which an output power of a radio wave emitted from the transmitting antenna 30 is maximized.
(2) The lens 215 is oriented to have the center axis C exactly or substantially coinciding with the target axis P that is an axis directed from the transmitting antenna 30 in the target direction (i.e., the radiating direction T).
(3) The distance L between the principal point S of the lens 215 and the transmitting antenna 30 exactly or substantially coincides with the focal length L_{f} of the lens 215.

### [1-2. Beneficial Effect]

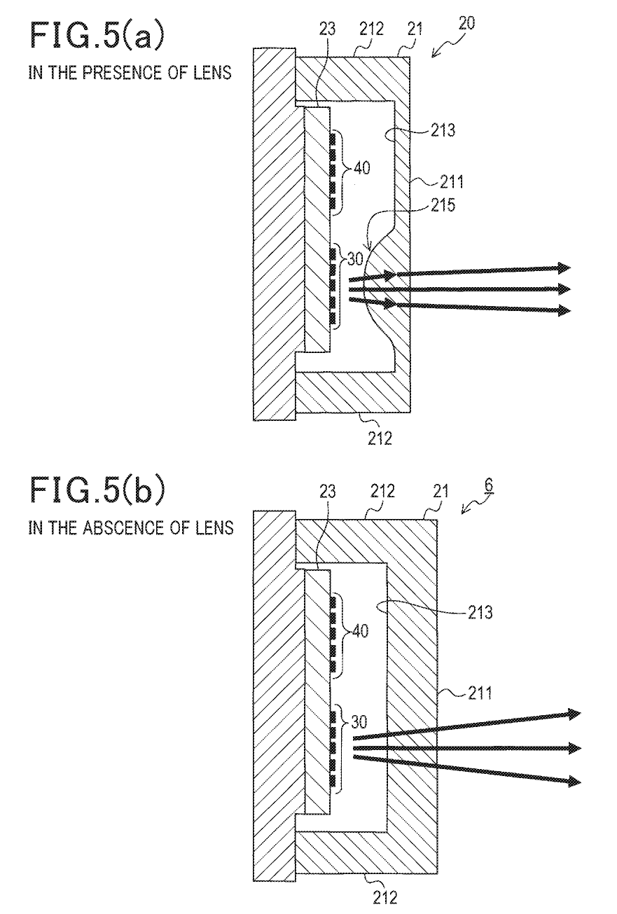

The above described first embodiment offers the following advantages.

[1A] The radar device 1 is equipped with the lens 215 formed in a convex shape on a portion of the cover 21 through which a radio wave is transmitted to the transmitting antenna 30. The radar device 1, as illustrated in FIG. 5(a), which is equipped with the lens 215 formed in a convex shape facilitates the ease with which radio waves are emitted substantially parallel to each other as compared with the radar device 6, as illustrated in FIG. 5(b), which is a comparative example not equipped with the convex lens 215.

In the radar device 1 of this embodiment designed to emit radio waves substantially parallel (see FIG. 5(a)), the strength of the radar waves on a plane which is defined at a given distance from the radar device 1, has a given area, and also has a normal line coinciding with the target axis P is greater than that in the radar device 6 (see FIG. 5(b)) in which radio waves diffuse.

Accordingly, the radar device 1 of this embodiment is designed to decrease an amplification factor of the amplifier 111 of the signal transmitter 11 when the radio wave is emitted from the transmitting antenna 30. In other words, electric power consumed to actuate the amplifier 111 is decreased. The structure of the cover 21, thus, serves to decrease the power consumption of the radar device 1.

[1B] The lens 215 is designed to have the center axis C oriented in coincidence with the radiating direction T of the transmitting antenna 30. This minimizes the spreading of a radio wave emitted from the transmitting antenna 30 and facilitates the collimation of the radio wave. Like the above [1A], the structure of the cover 21, thus, serves to decrease the power consumption of the radar device 1.
[1C] In this embodiment, the lens 215, as described above, has the center axis C oriented to coincide with the radiating direction T of the transmitting antenna 30 and is designed so that the distance L between the principal point S and the transmitting antenna 30 is identical with the focal length L_{f} of the lens 215. This causes rays of radio waves to be emitted from the transmitting antenna 30 parallel to the center axis of the lens 215.

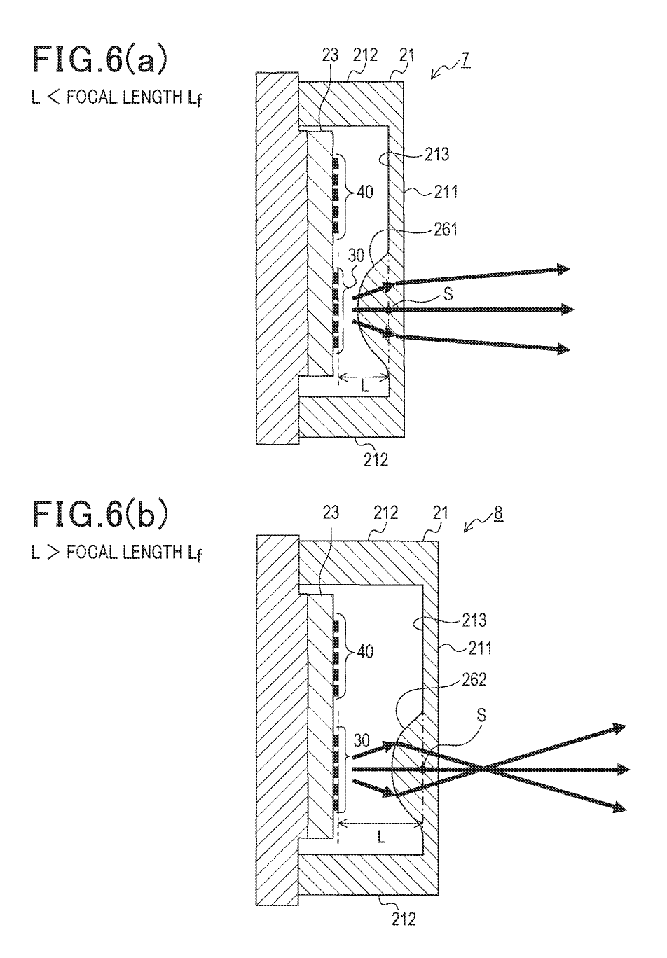

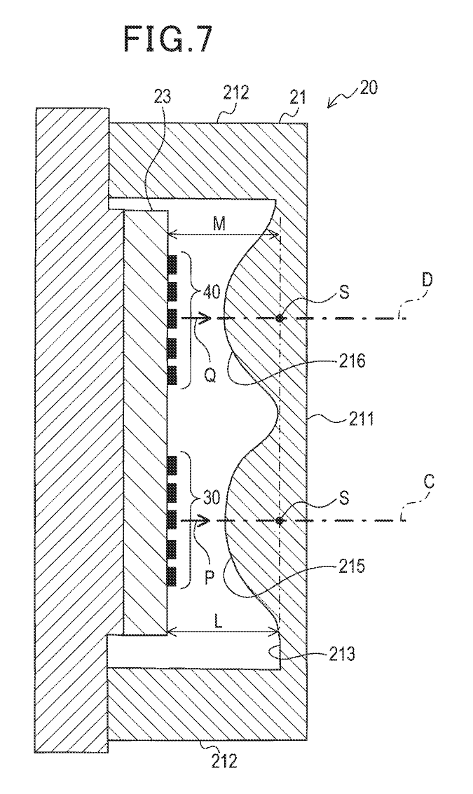

The power consumption is, therefore, decreased as compared with the radar device 7 that is a comparative example, as illustrated in FIG. 6(a), in which the distance L between the principal point S of the lens 261 and the transmitting antenna 30 is less than the focal length L_{f} of the lens 261. Additionally, the power consumption is decreased as compared with the radar device 8 that is a comparative example, as illustrated in FIG. 6(b), in which the distance L between the principal point S of the lens 262 and the transmitting antenna 30 is greater than the focal length L_{f} of the lens 262.

[1D] The cover 21 is shaped at least to cover the transmitting antenna 30, thereby decreasing the power consumption required to radiate the radio wave.

In the first embodiment, the transmitting antenna 30 is an example of a radar emitting section. The receiving antenna 40 is an example of a radar input section. The signal processor 15 is an example of a detector. The transmitting antenna 30 is an example of an object portion.

### [1-3. Modifications]

The cover 21 in the above embodiment has the lens 215 formed in a portion of the cover 21 through which the radio wave passes to the object portion (i.e., the transmitting antenna 30), but however, the structure of the cover 21 is not limited to it.

For example, the cover 21, as illustrated in F r be designed to have the lenses 215 and 216 formed on portions thereof through which radio waves pass toward object portions, i.e., the transmitting antenna 30 and the receiving antenna 40.

The lens 216 is, like the lens 215, shaped to meet all conditions (4) to (6) below.

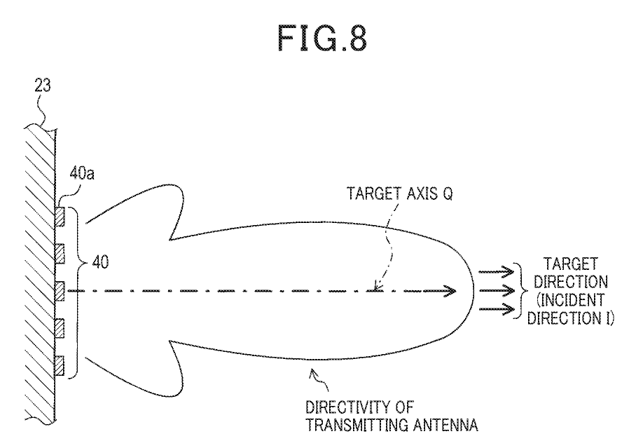

(4) The lens 216 is oriented to have the center axis D exactly or substantially coinciding with a target direction that is an incident direction I. The incident direction I is a direction in which an input power of a radio wave entering the receiving antenna 40 is maximized. The incident direction I, as referred to herein, is a direction, as illustrated in FIG. 8 as an example, in which the input power of the radio wave is maximized as viewed from the receiving antenna 40 and which is opposite a direction in which the radio wave enters the receiving antenna 40.
(5) The lens 216 is oriented to have the center axis D exactly or substantially coinciding with the target axis Q that is an axis directed from the receiving antenna 40 in the target direction (i.e., the incident direction I).
(6) The distance M between the principal point S of the lens 216 and the receiving antenna 40 exactly or substantially coincides with the focal length L_{f} of the lens 216.

The above conditions facilitate the ease with which the radar device 1 converges radio waves inputted through the lens 216 on the receiving antenna 40.

The radar device 2 of the modified form equipped with the lens 216 is, therefore, capable of decreasing the amplification factor of the amplifier 131 for reflected waves inputted into the signal receiver 13 through the receiving antenna 40. In other words, it is possible to reduce electrical power consumed to actuate the amplifier 131 as compared with the absence of the lens 216.

The cover 21 may be designed to have only the receiving antenna 40 as the object portion and also have a lens formed, like the lens 261, on a portion of the cover 21 through which radio waves pass to the object portion.

### 2. Second Embodiment

### [2-1. Structure]

The second embodiment basically has the same structure as in the first embodiment. Similar arrangements will, therefore, be emitted. Only differences will be discussed below.

In the first embodiment, the lens 215 is formed on the portion of the cover 21 through which radio waves are transmitted to the object portion, i.e., the transmitting antenna 30 so as to meet all the above conditions (1) to (3). The second embodiment defines the transmitting antenna 30 as the object portion and is designed to have the lens 271 formed on a location through which radio waves are transmitted to the object portion so as to meet only the above discussed condition (1).

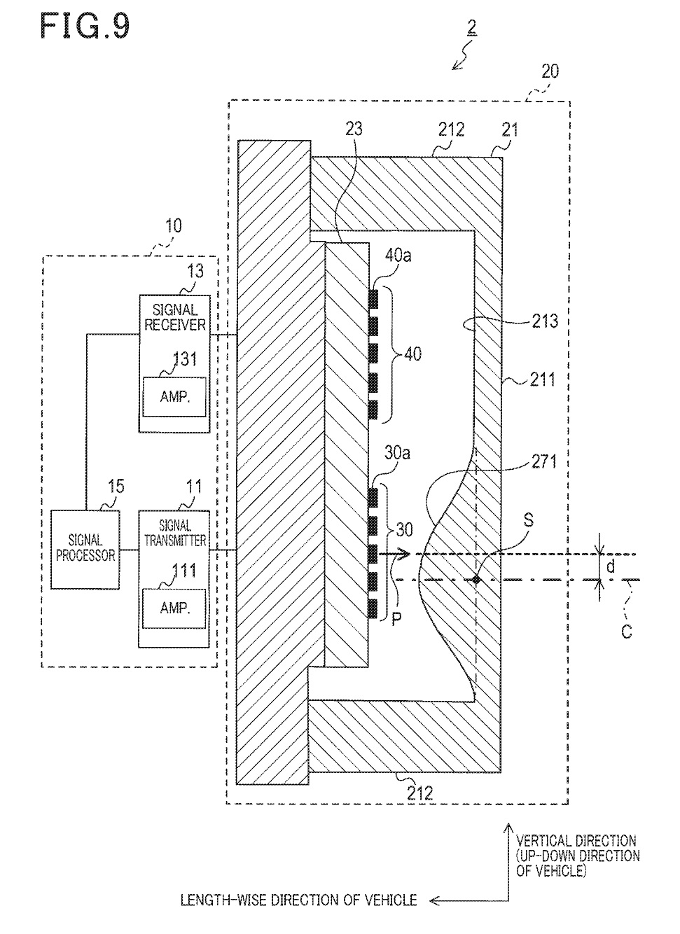

The radar device 2 of this embodiment, as illustrated in FIG. 9, has the lens 271 formed on the cover 21 to have the center axis C thereof which exactly or substantially coincides with the target direction (i.e., the radiating direction T illustrated in FIG. 3) of the transmitting antenna 30. In other words, the lens 271 is laid to have the center axis C parallel or substantially parallel to the target axis P of the transmitting antenna 30.

In this embodiment, a distance d1 between the center axis C and the target axis P of the transmitting antenna 30 on a plane defined to include the center axis C of the lens 271 as a normal line is selected to be approximately a few tenths of the focal length L_{f} of the lens 271. The distance d1 may alternatively be set to another value.

### [2-2. Beneficial Effects]

The second embodiment offers the following advantages.

[2A] The lens 271 has the center axis C oriented to exactly or substantially coincide with the target direction (the radiating direction 71 of the transmitting antenna 30. If the cover 21 is not equipped with the lens 271, there is a risk that radio waves emitted from the transmitting antenna 30 are reflected by the bumper 90 and then cancel radio waves subsequently radiated from the transmitting antenna 30. This embodiment serves to minimize such a risk.

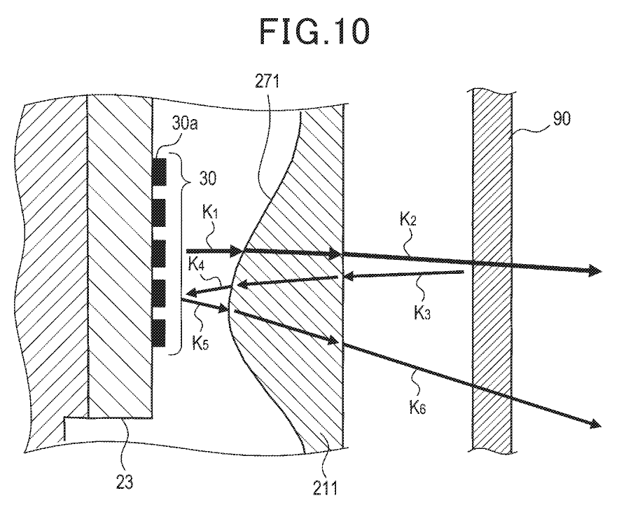

How to minimize the cancellation of radio waves transmitted from the radar device 2 of this embodiment will be described below with reference to FIG. 10 as an example.

The radio wave (K₁) emitted from the transmitting antenna 30 is, as illustrated in FIG. 10, refracted by the lens 271, reaches the bumper 90, and then passes through the bumper 90 in the form of a radio wave (K₂). A portion of the radio wave reaching the bumper 90 is reflected by the bumper 90 in the form of a radio wave (K₃). The radio wave reflected by the bumper 90 is refracted by the lens 271 and the reaches the transmitting antenna 30 in the form of a radio wave (K₄). The radio wave reaching the transmitting antenna 30 is reflected by the transmitting antenna 30 in the form of a radio wave (K₅). The radio wave (K₅) is then refracted by the lens 271 and reaches the bumper 90 again in the form of a radio wave (K₆).

In this embodiment, the radio wave (K₁) emitted from the transmitting antenna 30 is reflected by the bumper 90 in the form of the radio wave (K₃), however, it is directed by the transmitting antenna 30 in a direction different from the target direction of the transmitting antenna 30 in the form of the radio wave (K₆).

In the above way, a radio wave which has been emitted from the transmitting antenna 30 and then reflected by the bumper 90 is directed by the lens 271 in a direction different from the target direction (i.e., the radiating direction. R), thereby resulting in a decreased possibility of cancellation of the emitted radio wave, in other words, minimizing a decrease in output power of the emitted radio wave.

The radar device 2 in which the cover 21 is equipped with the lens 271 is, therefore, capable of decreasing the amplification factor of the amplifier 111 in the signal transmitter 11 as compared with a case where the cover 21 is not equipped with the lens 271. The structure of the cover 21, therefore, serves to decrease the power consumption of the radar device 2.

### [2-3. Modifications]

The above embodiment refers to the example where the cover 21 has the lens 271 formed in a portion thereof through which a radio wave is transmitted to the transmitting antenna 30 as the object portion, but it is not limited thereto.

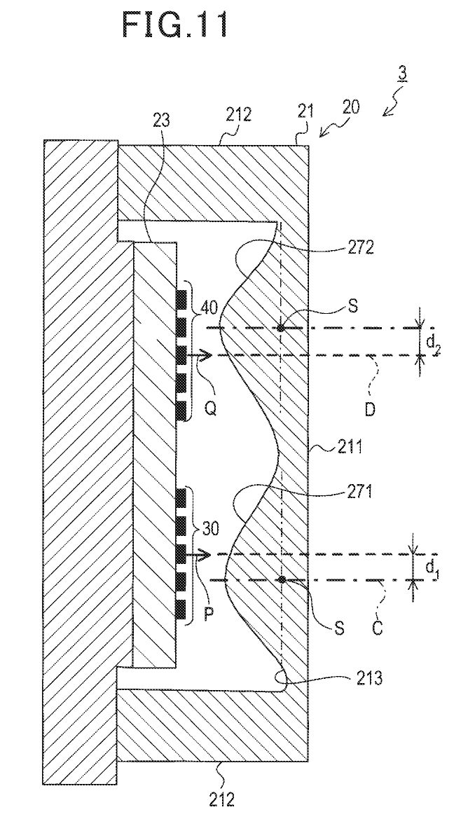

For instance, the cover 21, like in the radar device 3 in FIG. 11, may be equipped with the lenses 271 and 272 formed in the same way on portions of the cover 21 through which radio waves are transmitted to object portions, i.e., the transmitting antenna 30 and the receiving antenna 40, respectively.

The lens 272 has the center axis D exactly or substantially coinciding with the target direction (i.e., the incident direction I) of the receiving antenna 40. In other words, the lens 272 is oriented to have the center axis D extending exactly or substantially parallel to the target axis Q of the receiving antenna 40.

The distance d2 between the center axis D and the target axis Q of the receiving antenna 40 on a plane defined to include the center axis D of the lens 272 as a normal line is selected to be approximately a few tenths of the focal length L_{f} of the lens 272. The distance d2 may alternatively be set to another value.

The cover 21 may be designed to have only the receiving antenna 40 as the object portion and also have a lens formed, like the lens 272, on a portion of the cover 21 through which radio waves pass to the object portion.

### 3. Other Embodiments

While the embodiments of the invention have been discussed, the invention may be embodied in other various ways.

[3A] The above embodiments refer to the radar devices 1, 2, and 3 which use radio waves as electromagnetic waves, however, the radar devices 1, 2, and 3 may be engineered to use light as electromagnetic waves. In this case, the radar devices 1, 2, and 3 may be equipped with a light emitting device, such as a laser diode (LD), which emits light instead of the transmitting antenna 30 and a light-receiving device, such as a photodiode (PD) which receives light instead of the receiving antenna 40.
[3B] In the above embodiments, the transmitting antenna 30 is engineered to radiate radio waves in a predetermined azimuth range, but the radio waves may be emitted by the transmitting antenna 30 in another range. For instance, the transmitting antenna 30 may be designed to emit radio waves over a 360-degree range. The radiation, as referred to herein, means that radio waves are emitted to a preselected azimuth range or a 360-degree range.

Similarly, the light-emitting device which is, as discussed in [3A], used instead of the transmitting antenna 30 may be engineered to emit light in a preselected azimuth range or a 360-degree range.

[3C] In the above embodiments, the radar devices 1, 2, and 3 are mounted on the front surface of the vehicle 80 to detect an object existing in front of the vehicle 80, but however, the location of the radar devices 1, 2, and 3 or the object detectable range is not limited to the above. The radar devices 1, 2, and 3 may be mounted on the rear surface of the vehicle 80, or a right or left side surface of the vehicle 80 in a traveling direction of the vehicle 80 or may be designed to detect an object in a partial surrounding range or a 360-degree range of the vehicle 80.
[3D] In the above embodiments, the radar devices 1, 2, and 3 are equipped with the signal processor 15 working to detect an object using an electromagnetic wave inputted thereto, however, they are not limited to it. The radar devices 1, 2, and 3 may be designed to use an electronic control device equipped with a microcomputer which is different from the signal processor 15 to detect an object based on an electromagnetic wave inputted thereto. The radar devices 1, 2, and 3 may be designed to have a portion or all of a function to detect an object using an electromagnetic wave inputted thereto which is realized by software or hardware.
[3E] The function of one of the components in the above embodiments may be shared with some of the components. Alternatively, the functions of some of the components may be combined in one of the components. One or some of the components of the above embodiments may be omitted. At least a portion of the components of one of the above embodiments may be added to or replaced with the component(s) of the other embodiments. The embodiments of the invention may include various modes contained in technical ideas specified by wording of the appended claims.
[3F] The present invention may alternatively be realized in various ways by a system including the radar device 1, 2, or 3.

What is claimed is:

1. A radar device comprising:
a radar emitting section (30) which emits an electromagnetic wave;
a radar input section (40) into which a return of the electromagnetic wave from an object is inputted;
a detector (15) which detects the object using the return of the electromagnetic wave inputted to the radar input section; and
a cover (21) which covers an object portion that is at least one of the radar emitting section and the radar input section,
wherein the cover has a convex lens (215, 216, 271) formed on a portion of the cover through which the electromagnetic wave is transmitted to the object portion.

2. A radar device as set forth in claim 1, wherein when the object portion is the radar emitting section, the lens is configured to have a center axis thereof exactly or substantially coinciding with a target direction that is a radiating direction in which an output power of the electromagnetic wave emitted from the radar emitting section is maximized, or wherein when the object portion is the radar input section, the lens is configured to have a center axis thereof exactly or substantially coinciding with a target direction that is an incident direction in which an input power of the return of the electromagnetic wave entering the radar input section is maximized.

3. A radar device as set forth in claim 2, wherein the lens (215, 216) is oriented to have the center axis exactly or substantially coinciding with the target direction directed from the object portion in the target direction.

4. A radar device as set forth in claim 3, wherein a distance between a principal point of the lens and the object portion exactly or substantially identical with a focal length of the lens.

5. A radar device as set forth in any one of claims 1 to 4, wherein the radar emitting section is the object portion.

6. A radar device as set forth in any one of claims 1 to 5, wherein the radar input section is the object portion.
